(19) United States
(12) Patent Application Publication
(10) Pub. No.: US 2011/0139452 A1
(43) Pub. Date: Jun. 16, 2011

(54) SYSTEMS AND METHODS FOR PRODUCING OIL AND/OR GAS

(76) Inventor: Dean Chien Wang, Missouri City, TX (US)

(21) Appl. No.: 13/054,409

(22) PCT Filed: Jul. 14, 2009
(86) PCT No.: PCT/US09/50538

§ 371 Date: Feb. 21, 2011

Related U.S. Application Data
(60) Provisional application No. 61/080,434, filed on Jul. 14, 2008.

(51) Int. Cl. E21B 43/24; C09K 8/58

(52) U.S. Cl. 166/272.1; 166/60; 507/202

(57) ABSTRACT

A system for producing oil and/or gas comprising a formation comprising a mixture of oil and/or gas and an enhanced oil recovery mixture comprising an additive to increase an auto-ignition temperature of the mixture and a carbon disulfide formulation and/or a carbon oxysulfide formulation; and a mechanism for recovering at least a portion of the oil and/or gas.

### FIELD OF THE INVENTION

The present disclosure relates to systems and methods for producing oil and/or gas.

### BACKGROUND OF THE INVENTION

Substantial amounts of sour natural gas are currently being produced from natural gas wells, oil wells (for example, as associated gas), and from natural gas storage reservoirs that have been infected with hydrogen sulfide -producing bacteria. The presence of hydrogen sulfide and other sulfur compounds in fuel and other gases has long been of concern for both the users and the producers of such gases. In addition to the corrosive and other adverse effects that such impurities have upon equipment and processes, noxious emissions are commonly produced from combustion of the natural gas as a result of oxidation of the sulfur compounds. The resulting sulfur oxides can be a major contributor to air pollution and may have detrimental impact upon the environment. Increasingly stringent federal and state regulations have accordingly been promulgated in an effort to reduce or eliminate sulfurous emissions, and a concomitant interest exists in efficiently removing from natural gas and the like the hydrogen sulfide that comprises a significant precursor of noxious emissions. In addition, one method of disposing of hydrogen sulfide has been to convert it into solid sulfur, for storage. Due to environmental and aesthetic concerns, many countries are now outlawing the formation of such sulfur stores.

Enhanced Oil Recovery (EOR) may be used to increase oil recovery in fields worldwide. There are three main types of EOR, thermal, chemical/polymer and gas injection, which may be used to increase oil recovery from a reservoir, beyond what can be achieved by conventional means—possibly extending the life of a field and boosting the oil recovery factor.

Thermal enhanced recovery works by adding heat to the reservoir. The most widely practised form is a steamdrive, which reduces oil viscosity so that it can flow to the producing wells. Chemical flooding increases recovery by reducing the capillary forces that trap residual oil. Polymer flooding improves the sweep efficiency of injected water. Miscible gas injection works in a similar way to chemical flooding. By injecting a fluid that is miscible with the oil, trapped residual oil can be recovered.

Referring to FIG. 1, there is illustrated prior art system 100. System 100 includes underground formation 102, underground formation 104, underground formation 106, and underground formation 108. Production facility 110 is provided at the surface. Well 112 traverses formations 102 and 104, and terminates in formation 106. The portion of formation 106 is shown at 114. Oil and gas are produced from formation 106 through well 112, to production facility 110. Gas and liquid are separated from each other, gas is stored in gas storage 116 and liquid is stored in liquid storage 118. Gas in gas storage 116 may contain hydrogen sulfide, which must be processed, transported, disposed of, or stored.

Co-Pending Patent Application Publication 2006/0254769 discloses a system including a mechanism for recovering oil and/or gas from an underground formation, the oil and/or gas comprising one or more sulfur compounds; a mechanism for converting at least a portion of the sulfur compounds from the recovered oil and/or gas into a carbon disulfide formulation; and a mechanism for releasing at least a portion of the carbon disulfide formulation into a formation. Publication 2006/0254769 is herein incorporated by reference in its entirety.

U.S. Pat. No. 3,644,433 discloses that 5 to 40 liquid volume percent of catalytically cracked and coker naphthas boiling below 250 F when added to carbon disulfide results in a large increase in the autoignition temperature of the carbon disulfide. U.S. Pat. No. 3,644,433 is herein incorporated by reference in its entirety.

U.S. Pat. No. 3,375,192 discloses that mixtures of carbon disulphide and petroleum pentane possess much lower flammability characteristics than mixtures of carbon disulphide with hydrocarbons of higher boiling point and mixtures of carbon disulphide and chlorinated hydrocarbons. U.S. Pat. No. 3,375,192 is herein incorporated by reference in its entirety.

U.S. Pat. No. 3,558,509 discloses that compositions comprising a major proportion of carbon disulfide and a minor amount of an additive which have an autogenous ignition temperature substantially greater than that of carbon disulfide. The additives may belong to the class of substances consisting of: (A) Organic sulfides and disulfides with the formulae RSR′ and RSSR′, respectively, wherein R and R′ are alkyl or alkenyl radicals each containing up to about 5 carbon atoms, inclusive, including such radicals as methyl, ethyl, n-propyl, isopropyl, n-butyl, isobutyl, tert.-butyl, isopentyl, n-pentyl, and allyl, etc. R and R′ need not be the same. (B) Dimethyl sulfoxide. The above-described additives may be introduced directly into liquid or vaporized carbon disulfide. The amount of additive used should be between about 0.1% and 10% by weight, and preferably between about 0.2% and 5% by weight. The additive chosen and the amount used may be varied depending on the particular requirements for the properties of the carbon disulfide. The additives may be used singly or in combination. U.S. Pat. No. 3,558,509 is herein incorporated by reference in its entirety.

U.S. Pat. No. 3,558,510 discloses that when minor amounts of iodine, bromine or ethyl alcohol are added to carbon disulfide, they significantly raise its autogenous ignition temperature. One or more of the above-described additives may be introduced directly into liquid or vaporized carbon disulfide. The amount of additive used should be between about 0.1% and 10% by weight, and preferably between about 0.2% and 5% by weight. The additive chosen and the amount used may be varied depending on the particular requirements for the properties of the carbon disulfide. The additives may be used singly or in combination. U.S. Pat. No. 3,558,510 is herein incorporated by reference in its entirety.

There is a further need in the art for improved systems and methods for enhanced oil recovery. There is a further need in the art for improved systems and methods for enhanced oil recovery using a sulfur compound, for example through viscosity reduction, chemical effects, and miscible flooding. There is a further need in the art for improved systems and methods for raising the auto-ignition temperature of sulfur containing enhanced oil recovery agents.

### SUMMARY OF THE INVENTION

In one aspect, the invention provides a system for producing oil and/or gas comprising a formation comprising a mixture of oil and/or gas and an enhanced oil recovery mixture comprising an additive to increase an auto-ignition temperature of the mixture and a carbon disulfide formulation and/or a carbon oxysulfide formulation; and a mechanism for recovering at least a portion of the oil and/or gas.

In another aspect, the invention provides a method for producing oil and/or gas comprising providing a formation comprising oil and/or gas; and releasing an enhanced oil recovery mixture into the formation, the mixture comprising an additive adapted to increase an auto-ignition temperature of the mixture and at least one of carbon disulfide and/or carbon disulfide.

Advantages of the invention include one or more of the following:

Improved systems and methods for disposing of hydrogen sulfide, sulfur, and/or other sulfur based compounds.

Improved systems and methods for enhanced recovery of hydrocarbons from a formation with a carbon disulfide formulation.

Improved systems and methods for enhanced recovery of hydrocarbons from a formation with a fluid containing a carbon disulfide formulation.

Improved systems and methods for raising the auto-ignition temperature of a carbon disulfide formulation.

Improved carbon disulfide containing compositions for secondary recovery of hydrocarbons.

Improved systems and methods for enhanced oil recovery.

Improved systems and methods for enhanced oil recovery using a sulfur compound.

Improved systems and methods for enhanced oil recovery using a compound which is miscible with oil in place.

Improved systems and methods for making and/or using sulfur containing enhanced oil recovery agents.

### BRIEF DESCRIPTION OF THE DRAWINGS

FIG. 1 illustrates an oil and/or gas production system.

FIG. 2 illustrates a process flow.

FIGS. 3a-3d illustrate oil and/or gas production systems.

FIG. 4 illustrates a carbon disulfide formulation production process.

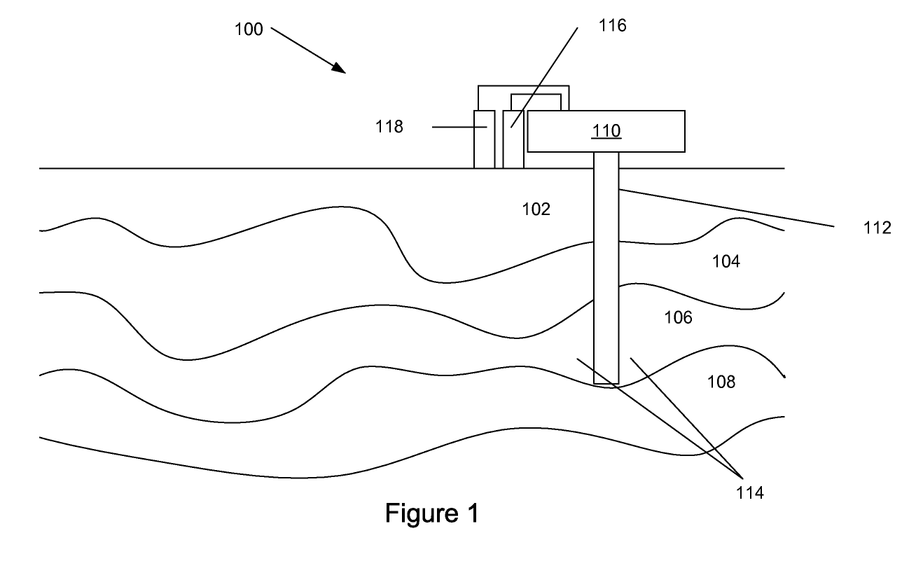

### DETAILED DESCRIPTION OF THE INVENTION

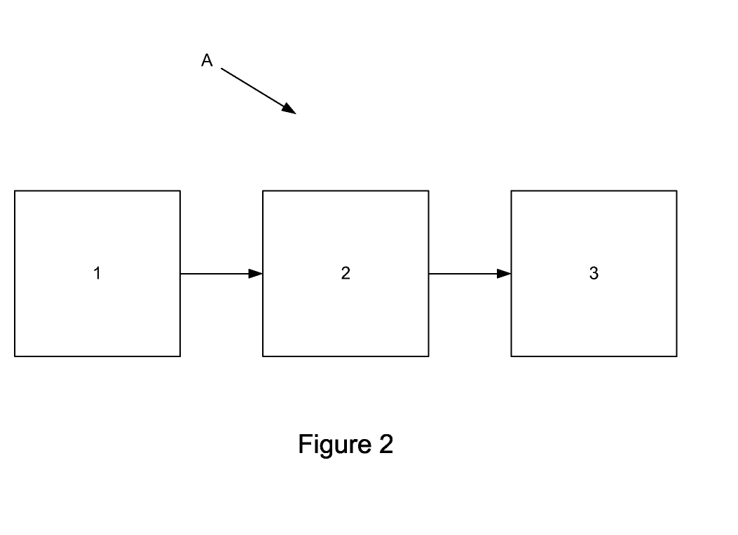

FIG. 2:

In some embodiments of the invention, a process A is illustrated for use in an enhanced oil recovery process.

In step 1, a carbon disulfide formulation and/or a carbon oxysulfide formulation may be manufactured and/or purchased. Suitable methods of manufacturing a carbon disulfide formulation and/or a carbon oxysulfide formulation are disclosed below. The method chosen to manufacture a carbon disulfide formulation and/or a carbon oxysulfide formulation is not critical.

In step 2, an additive is introduced to the carbon disulfide formulation and/or the carbon oxysulfide formulation in order to raise the auto-ignition temperature and/or the lower flammability limits.

In step 3, the additive and carbon disulfide formulation and/or the carbon oxysulfide formulation mixture is used in a enhanced oil recovery process.

Step 1

In some embodiments, a sulfur compound may be converted to sulfur and/or sulfur dioxide, for which processes are disclosed in U.S. patent application publication numbers 2004/0096381, 2004/0022721, 2004/0159583, 2003/0194366, 2001/0008619, 2002/0134706, 2004/0096381, 2004/0022721, 2004/0159583, and 2001/0008619, the disclosures of which are herein incorporated by reference in their entirety.

In some embodiments, sulfur and/or sulfur dioxide and a carbon compound may be converted to carbon disulfide formulation, processes for which are disclosed in U.S. Pat. Nos. 4,963,340, 2,636,810, 3,927,185, 4,057,613, and 4,822,938, and U.S. patent application publication number 2004/0146450, the disclosures of which are herein incorporated by reference in their entirety.

One suitable method of converting liquid sulfur and a hydrocarbon into a carbon disulfide formulation in the absence of oxygen is disclosed in WO 2007/131976. WO 2007/131976 is herein incorporated by reference in its entirety.

One suitable method of converting liquid sulfur and a hydrocarbon into a carbon disulfide formulation in the presence of oxygen is disclosed in WO 2007/131977. WO 2007/131977 is herein incorporated by reference in its entirety.

Other suitable methods for converting sulfur compounds into a carbon disulfide formulation and/or a carbon oxysulfide formulation are disclosed in co-pending patent applications: U.S. Patent Publication 2006/0254769 having attorney docket number TH2616; U.S. Provisional Application 61/031,832 having attorney docket number TH3448; U.S. Provisional Application 61/024,694 having attorney docket number TH3443; PCT Patent Publication WO 2007/131976 having attorney docket number TS1746; PCT Patent Publication WO 2008/003732 having attorney docket number TS1818; PCT Patent Publication WO 2007/131977 having attorney docket number TS1833; and PCT Patent Application PCT/EP2007/059746 having attorney docket number TS9597, which are all herein incorporated by reference in their entirety.

As discussed above, the reaction inputs and/or catalysts may be used in a surface process or found within the formation or injected into the formation in order to convert a sulfur containing compound into a carbon disulfide formulation and/or a carbon oxysulfide formulation.

Step 2:

An additive is introduced to the carbon disulfide formulation and/or the carbon oxysulfide formulation in order to raise the auto-ignition temperature and/or the lower flammability limits.

Suitable additives include hydrogen sulfide, carbon dioxide, hydrocarbons such as alkanes, disulfide compounds, and/or mixtures thereof.

In some embodiments, the additive includes at least about 1% (molar) of butane, at least about 1% (molar) of pentane, at least about 1% (molar) of hexane, and at least about 1% (molar) of heptane.

In some embodiments, the additive includes at least about 2% (molar) of butane, at least about 2% (molar) of pentane, at least about 2% (molar) of hexane, and at least about 2% (molar) of heptane.

In some embodiments, the mixture with the additive and the carbon disulfide formulation and/or the carbon oxysulfide formulation includes at least about 25% (molar) of carbon disulfide, for example at least about 50%, at least about 75%, or at least about 90%.

In some embodiments, the mixture with the additive and the carbon disulfide formulation and/or the carbon oxysulfide formulation includes at least about 25% (molar) of carbon oxysulfide, for example at least about 50%, at least about 75%, or at least about 90%.

In some embodiments, the additive includes at least about 5% (molar) of hydrogen sulfide, for example at least about 10%, at least about 20%, at least about 30%, or at least about 50%.

In some embodiments, the additive includes at least about 5% (molar) of carbon dioxide, for example at least about 10%, at least about 20%, at least about 30%, or at least about 50%.

In some embodiments, the additive includes at least about 0.5% (volume) of a disulfide compound, for example at least about 1%, at least about 2%, at least about 3%, or at least about 5%. In some embodiments, suitable disulfide compounds include dimethyl disulfide, diethyl disulfide, and mixtures thereof.

Step 3:

Carbon disulfide formulation and/or a carbon oxysulfide formulation may be produced in a surface process and/or produced within a formation. The carbon disulfide formulation and/or a carbon oxysulfide formulation may then be mixed with an additive and then used in an enhanced oil recovery (EOR) process to boost the production of oil from the formation, for example as disclosed in co-pending patent application TH2616, which is herein incorporated by reference in its entirety. A mixture of oil and the carbon disulfide formulation may be produced to the surface, the carbon disulfide formulation separated, and optionally recycled to be injected into the formation or into another formation.

An enhanced oil recovery mixture including at least one of a carbon disulfide formulation and a carbon oxysulfide formulation is mixed with an additive to increase the autogenous ignition temperature of the enhanced oil recovery mixture. The mixture is then introduced into an underground formation, for example through an injection well. At least a portion of the mixture and oil and/or gas from the formation may then be produced to a production well, which could be the same well as the injection well or another well at a distance across the formation from the injection well.

Various methods and systems for injecting enhanced oil recovery mixtures into a formation and producing oil and/or gas from the formation are known in the art. The selection of the method to inject the enhanced oil recovery mixture and to produce oil and/or gas from the formation is not critical.

The recovery of oil and/or gas from an underground formation may be accomplished by any known method. Suitable methods include subsea production, surface production, primary, secondary, or tertiary production. The selection of the method used to recover the oil and/or gas from the underground formation is not critical.

In one embodiment, oil and/or gas may be recovered from a formation into a well, and flow through the well and flowline to a facility. In some embodiments, enhanced oil recovery, with the use of an agent for example steam, water, a surfactant, a polymer flood, and/or a enhanced oil recovery mixture such as a carbon disulfide formulation, may be used to increase the flow of oil and/or gas from the formation.

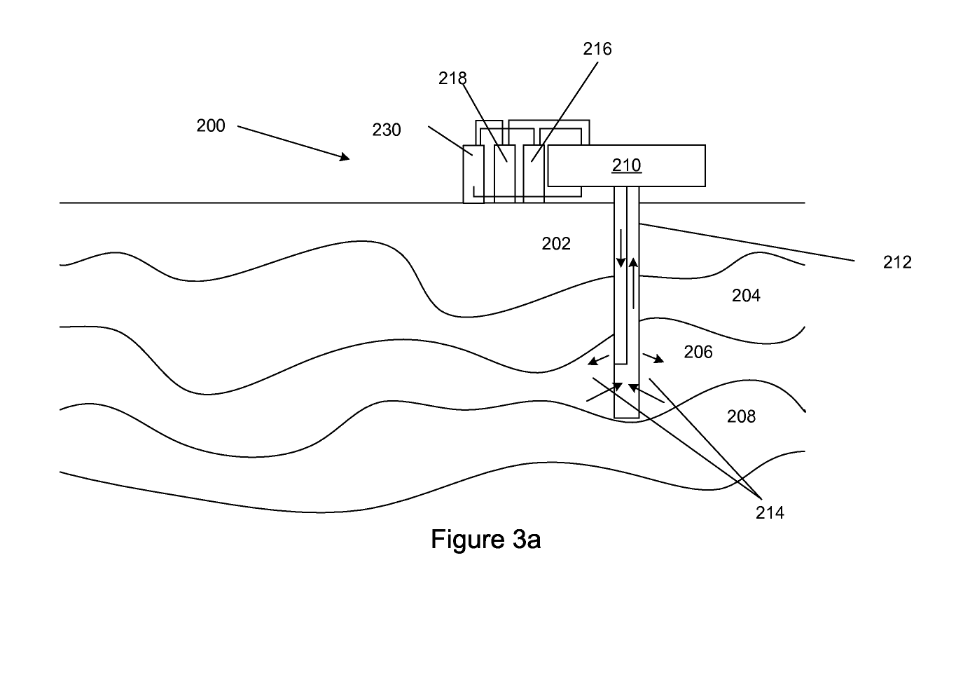

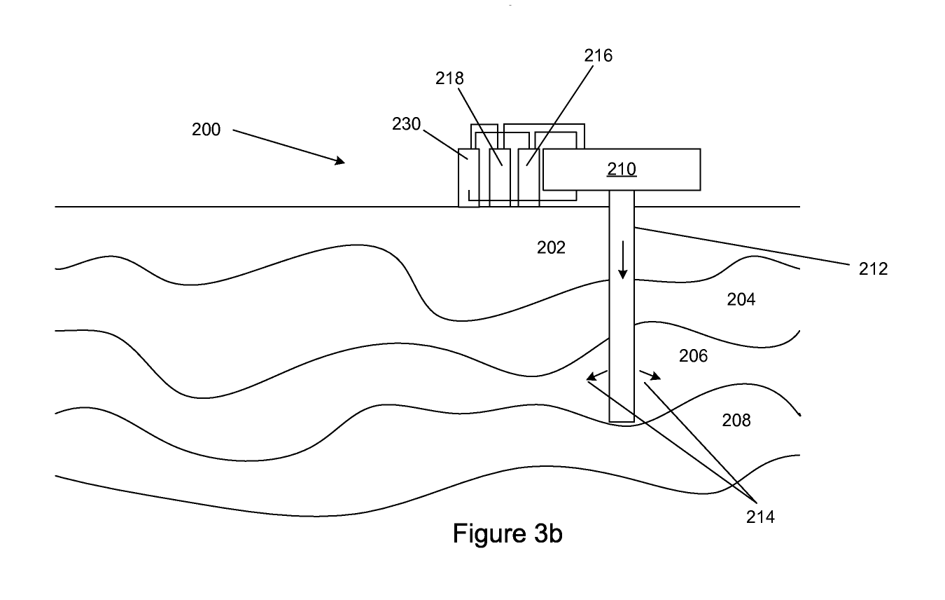

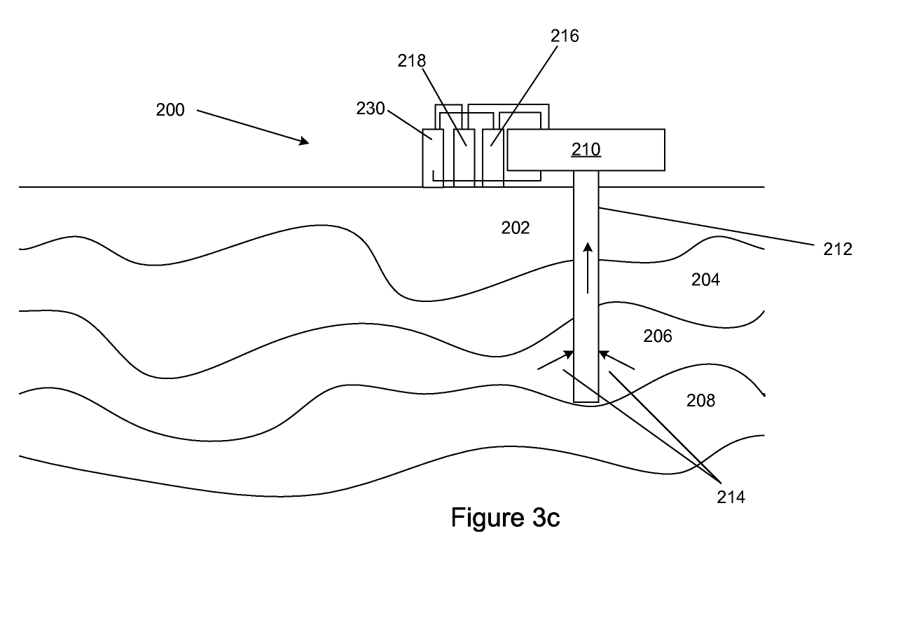

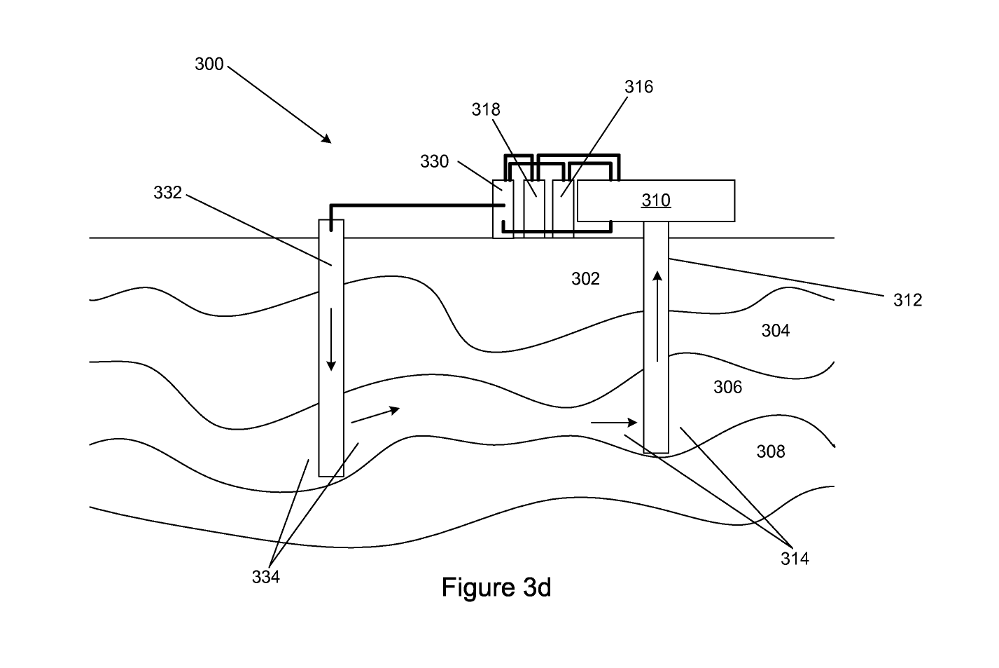

FIG. 3a:

Referring now to FIG. 3a, in one embodiment of the invention, system 200 is illustrated. System 200 includes underground formation 202, underground formation 204, underground formation 206, and underground formation 208. Production facility 210 is provided at the surface. Well 212 traverses formations 202 and 204, and has openings in formation 206. Portions 214 of formation 206 may optionally be fractured and/or perforated. Oil and gas from formation 206 is produced into portions 214, into well 212, and travels up to production facility 210. Production facility may then separate gas, which is sent to gas processing 216, and liquid, which is sent to liquid storage 218. Production facility also includes carbon disulfide formulation storage 230. Carbon disulfide, hydrogen sulfide and/or other sulfur containing compounds produced from well 212 may be sent to carbon disulfide formulation production 230. Carbon disulfide, hydrogen sulfide and/or other sulfur containing compounds with an additive may be pumped down well 212 that is shown by the down arrow and is pumped into formation 206, and is then separated and the oil and gas produced back up well 212 to production facility 210.

FIGS. 3b & 3c:

Referring now to FIGS. 3b and 3c, in some embodiments of the invention, system 200 is illustrated. System 200 includes underground formation 202, underground formation 204, underground formation 206, and underground formation 208. Production facility 210 is provided at the surface. Well 212 traverses formations 202 and 204, and has openings in formation 206. Portions 214 of formation 206 may be optionally fractured and/or perforated. During primary production, oil and gas from formation 206 is produced into portions 214, into well 212, and travels up to production facility 210. Production facility then separates gas, which is sent to gas processing 216, and liquid, which is sent to liquid storage 218. Production facility also includes carbon disulfide formulation storage 230. Carbon disulfide formulation, hydrogen sulfide and/or other sulfur containing compounds may be separated from oil and/or gas within the formation, before the oil and/or gas is produced into well 212, or after the oil and/or gas is produced into well 212 and to a surface facility. As shown in FIG. 3b, enhanced oil recovery mixtures with an additive may be pumped down well 212 that is shown by the down arrow and pumped into formation 206. Enhanced oil recovery mixtures may be left to soak in formation for a period of time from about 1 hour to about 15 days, for example from about 5 to about 50 hours, in order to react with hydrocarbons to form a enhanced oil recovery mixture—oil formulation.

After the soaking/reaction period, as shown in FIG. 3c, enhanced oil recovery mixture may be produced with the oil and/or gas, back up well 212 to production facility 210.

In some embodiments, enhanced oil recovery mixture may be pumped into formation 206 above the fracture pressure of the formation, for example from about 120% to about 200% of the fracture pressure.

Enhanced oil recovery mixture may be pumped into formation 206 at a temperature from about 20 to about 1000° C., for example from about 50 to about 500° C., or from about 75 to about 200° C.

Enhanced oil recovery mixture may be pumped into formation 206 at a pressure from about 2 to about 200 bars, for example from about 3 to about 100 bars, or from about 5 to about 50 bars.

FIG. 3d:

Referring now to FIG. 3d, in some embodiments of the invention, system 300 is illustrated. System 300 includes underground formation 302, formation 304, formation 306, and formation 308. Production facility 310 is provided at the surface. Well 312 traverses formation 302 and 304 has openings at formation 306. Portions of formation 314 may be optionally fractured and/or perforated. As oil and gas is produced from formation 306 it enters portions 314, and travels up well 312 to production facility 310. Gas and liquid may be separated, and gas may be sent to gas storage 316, and liquid may be sent to liquid storage 318. Production facility 310 is able to store and/or produce a carbon disulfide formulation, which may be produced and stored in carbon disulfide formulation production 330. Carbon disulfide formulation, hydrogen sulfide and/or other sulfur containing compounds may be separated from oil and/or gas, after the oil and/or gas is produced to well 312 and to surface facilities. Carbon disulfide formulation may also be optionally recycled back to the formation, or to another formation.

A carbon disulfide and/or a carbon oxysulfide formulation, and an additive may be pumped down well 332, to portions 334 of formation 306. The carbon disulfide and/or the carbon oxysulfide formulation traverses formation 306 and reacts with one or more hydrocarbons to make a miscible oil mixture with the carbon disulfide and/or carbon oxysulfide formulation, which aids in the production of oil and gas, and then the mixture may be produced to well 312 and to production facilities 310, and then the carbon disulfide formulation and oil and/or gas may be separated. Carbon disulfide formulation may then be recycled and reinjected into the formation or to another target formation.

In some embodiments, carbon disulfide formulation or carbon disulfide formulation mixed with other components may be miscible in oil and/or gas in formation 306.

In some embodiments, carbon disulfide formulation or carbon disulfide formulation mixed with other components may be mixed in with oil and/or gas in formation 306 to form a miscible mixture. The mixture may then be produced to well 312, then separated.

In some embodiments, carbon disulfide formulation or carbon disulfide formulation mixed with other components may not mix in with oil and/or gas in formation 306, so that carbon disulfide formulation or carbon disulfide formulation mixed with other components travels as a plug across formation 306 to force oil and/or gas to well 312. In some embodiments, a quantity of carbon disulfide formulation or carbon disulfide formulation mixed with other components may be injected into well 332, followed by another component to force carbon disulfide formulation or carbon disulfide formulation mixed with other components across formation 306, for example air; water in gas or liquid form; water mixed with one or more salts, polymers, and/or surfactants; carbon dioxide; other gases; other liquids; and/or mixtures thereof.

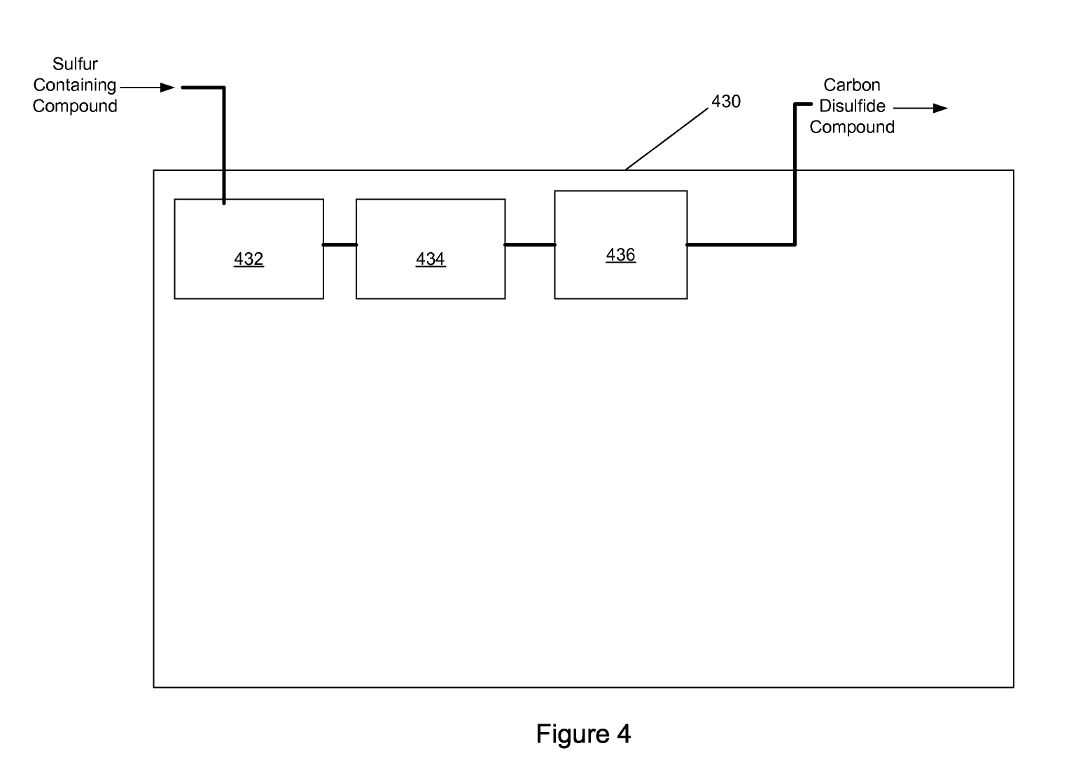

FIG. 4:

Referring now to FIG. 4, in some embodiments of the invention, carbon disulfide formulation production 430 is illustrated. Carbon disulfide formulation production 430 has an input of hydrogen sulfide and/or other sulfur containing compounds. Hydrogen sulfide may be converted into sulfur dioxide by oxidation reaction 432. Hydrogen sulfide and sulfur dioxide may be converted to sulfur at 434. Sulfur may be combined with a carbon compound to produce carbon disulfide formulation at 436. The carbon disulfide formulation and hydrogen sulfide produced at 436 may be the output. Carbon disulfide formulation and/or a carbon disulfide formulation containing mixture may be the output from carbon disulfide formulation production 430.

Alternatives:

In some embodiments, carbon disulfide derived salts can be dissolved in water, and the resulting solution pumped into formations 206 and/or 306. The dissolved carbon disulfide formulations may decompose, yielding carbon disulfide in formations 206 and/or 306.

In some embodiments of the invention, gas and liquid produced from well 212 and/or 312 may be separated, for example with a gravity separator or a centrifuge, or with other methods known in the art. The gas portion may be sent to carbon disulfide formulation production 230 and/or 330.

In some embodiments of the invention, all of the components of system 200 and/or system 300 may be within about 10 km of each other, for example about 5, 3, or 1 km.

In some embodiments, oil and/or gas produced from well 212 and/or 312 may be transported to a refinery and/or a treatment facility. The oil and/or gas may be processed to produced to produce commercial products such as transportation fuels such as gasoline and diesel, heating fuel, lubricants, chemicals, and/or polymers. Processing may include distilling and/or fractionally distilling the oil and/or gas to produce one or more distillate fractions. In some embodiments, the oil and/or gas, and/or the one or more distillate fractions may be subjected to a process of one or more of the following: catalytic cracking, hydrocracking, hydrotreating, coking, thermal cracking, distilling, reforming, polymerization, isomerization, alkylation, blending, and dewaxing.

It is to be appreciated that any of the embodiments to complete Step 1 may be combined with any of the embodiments to complete Step 2, which may be combined with any of the embodiments to complete Step 3.

The selection of a method to complete any of Steps 1-3 is not critical.

Examples

Table 1 presents flammability properties of carbon disulfide, including the flash point, autoignition temperature, and flammability limits in air at 25° C. It also gives the corresponding flammability data for other common oil field and chemical industry substances. As can be seen, the distinguishing feature of the carbon disulfide solvent is its very low autoignition temperature, or the minimum temperature at which it can spontaneously ignite in the presence of air in the absence of an ignition source. The wide flammability limits makes this ignition even more likely. Even the highly combustible hydrocarbons (i.e. octane and decane) and hydrocarbon mixtures (i.e. diesel or LPG) have autoignition temperatures more than 100° C. greater and possess much narrower flammability limits. In fact, the low autoignition temperature puts carbon disulfide in a class by itself in terms of flammability, with reported episodes, for example, of fires caused by the contact of wafting Carbon disulfide vapors with an incandescent bulb.

TABLE 1
Flammability Properties of Carbon disulfide and Select Compounds

| | | | Flammability | |
|---|---|---|---|---|
| | | | Limits | |
| | | Autoignition | (vol % at 25° C.) | |
| Substance | Flash Point (° C.) | Temperature (° C.) | Lower | Upper |
| Gamba | −30 | 100 | <1 | 50 |
| Methane | −188 | 630 | 5 | 15 |
| Ethane | −135 | 515 | 3 | 12.4 |
| Propane | −104 | 450 | 2.1 | 9.5 |
| n-Butane | −74 | 370 | 1.8 | 8.4 |
| n-Pentane | −49 | 260 | 1.4 | 7.8 |
| n-Hexane | −23 | 225 | 1.2 | 7.4 |
| n-Heptane | −3 | 225 | 1.1 | 6.7 |
| n-Octane | 14 | 220 | 0.95 | 6.5 |
| n-Nonane | 31 | 205 | 0.95 | — |
| n-Decane | 46 | 210 | 0.75 | 5.6 |
| H₂S | −82 | 270 | 4 | 46 |
| Ethanol | 19 | 365 | 3 | 19 |
| Isoprene | −54 | 395 | 1 | 9 |
| Dimethyl | 90 | 300 | 3 | 63 |
| sulfoxide | | | | |
| (DMSO) | | | | |
| Petrol | −45 | 246 | 1 | 7 |
| Hydrogen | −253 | 530 | 4 | 75 |
| Kerosene | 35 | 210 | 1 | 5 |
| Diesel | 45 | 210 | 0.3 | 10 |
| Naphtha | 40 | 277 | — | — |
| LPG | −30 | — | — | — |

By contrast, the flash point, or the temperature needed for a substance to burn in the presence of an ignition source such as a spark or a flame, while low, is not extreme compared with the other compounds listed in Table 1.

### Flammability Testing Procedures

Flammability testing of Carbon disulfide mixtures was performed following the procedures of the American Society for Testing and Materials (ASTM), the international standards organization. Three sets of tests were conducted, focusing on mixtures with H₂S and/or CO₂, mixtures involving hydrocarbons, and mixtures with small quantities of disulfide compounds (i.e. dimethyl disulfide, diethyl disulfide, and others). Parameters measured included the autoignition temperatures and the lower flammability limits of the various mixtures. Details of the experiments are given below.

### Flammability Limits

The Lower Flammability Limit (LFL) is the minimum concentration of a flammable gas or vapor that is capable of propagating a flame through a homogeneous gas mixture. Tests for LFL were conducted according to the ASTM E-681 procedure, whereby a uniform mixture of gas or vapor is ignited in a closed vessel, and the upward and downward propagation of the flame away from the ignition source is noted by visual inspection. The concentration of the flammable component is varied until a propagating flame observed.

In the case of carbon disulfide mixtures, the experiments were conducted in a 2.25 liter cylindrical vessel, equipped with the necessary piping connections and instrumentation to facilitate testing. Given the hazardous nature of carbon disulfide, as well as many of the other components in the mixture, the test vessel was placed in a high-pressure barricade, and ignition attempts were conducted remotely from the barricade control room. Prior to testing, the empty vessel was cleaned with water, dried with dry air, and leak-tested. The vessel was then heated to the required testing temperature, purged with air, and vacuumed to 0 psia. Afterwards, air was added to the vessel, followed by the Carbon disulfide mixture to be tested. Ignition attempts were made using a high voltage constant arc (10 kV, 0.25 mA) at normal atmospheric conditions (14.7 psia), and the occurrence of ignition was determined by a rise in pressure and temperature as measured by the data-acquisition system.

### Autoignition Temperature

The Autoignition Temperature (AIT) of a substance is the lowest temperature at which the material will spontaneously ignite in the absence of an external ignition source, such as a spark or flame. Tests for AIT were conducted according to the ASTM E-659 procedure, whereby the substance is introduced into a uniformly heated glass flask and observed for ten minutes or until ignition occurs. The flask temperature and the concentration of the material in the flask is varied until the AIT is identified.

As for the LFL experiments, the AIT experiments were conducted in a 2.25 liter cylindrical vessel, equipped with the necessary piping connections and instrumentation to facilitate testing. The same setup was also utilized, with the placement of the test vessel in a high-pressure barricade, and observations made remotely from the barricade control room. Prior to testing, the empty vessel was cleaned with water, dried with dry air, and leak-tested. The vessel was then heated to the required testing temperature, purged with air, and vacuumed to 0 psia. Afterwards, air was added to the vessel, followed by the carbon disulfide mixture, with the concentrations carefully measured as they were introduced into the vessel. The test vessel was then observed for ten minutes for ignition, and the occurrence of ignition was determined by a rise in pressure and temperature as measured by the data-acquisition system.

Flammability Results for Carbon Disulfide Mixtures with H₂S and CO₂

Table 2 presents the results for flammability testing of some carbon disulfide mixtures with H₂S and/or CO₂. As can be seen, the addition of H₂S into carbon disulfide increases the autoignition temperature—to 130° C. with 5% H₂S and 174° C. with 50% H₂S. The flammability limits are little changed, however, with the LFL ranging from less than 1% for pure carbon disulfide to 1.6% and 1.9% for carbon disulfide mixtures with 5% and 50% H₂S, respectively. By contrast, the autoignition temperature is little changed when carbon disulfide/CO₂ mixtures are created relative to pure carbon disulfide, but the lower flammability limits are raised moderately. Interestingly, the LFL is higher for the 80% carbon disulfide/20% CO₂ mixture than for the 35% carbon disulfide/65% CO₂ mixture, suggesting that the LFL does not increase monotonically for increasing CO₂ concentrations. Finally, the last line of Table 2 indicates that Carbon disulfide mixtures with both H₂S and CO₂ can possess both higher autoignition temperatures and flammability limits.

TABLE 2
Flammability Testing Results for Carbon disulfide Mixtures
with H₂S and CO₂

| Mixture Composition | | | | |
|---|---|---|---|---|
| (mol %) | | | | |
| Gamba | CO₂ | H₂S | AIT (° C.) | LFL |
| 95% | 0% | 5% | 130 | 1.6% |
| 50% | 0% | 50% | 174 | 1.9% |
| 80% | 20% | 0% | 97 | 5.4% |
| 35% | 65% | 0% | 97 | 3.0% |
| 40% | 15% | 45% | 167 | 4.0% |

Flammability Results for Carbon Disulfide Mixtures with Hydrocarbons

Flammability tests were also performed on carbon disulfide hydrocarbon mixtures. Table 3 presents the data for the AIT and LFL for these mixtures. In general, at the 96% Carbon disulfide/4% hydrocarbon level, the increases in AIT over pure Carbon disulfide are modest. For mixture compositions of 92% Carbon disulfide/8% hydrocarbon, the increases in AIT are larger, with the most pronounced effects for the heavier hydrocarbons. This is somewhat contrary to expectations, as the AIT for pure hydrocarbons decreases for increasing molecular weight (Table 1).

When hydrocarbons are added, the lower flammability limits are increased slightly, to approximately 2%, with very little difference between the 4% and 8% hydrocarbon addition levels. Adding hydrocarbon mixtures, as opposed to pure hydrocarbons, to the carbon disulfide fluid produces results that lie roughly in the same range as for adding the corresponding pure hydrocarbons. The last mixture in Table 3, however, yields an autoignition temperature higher than for any of its constituent components added in comparable amounts.

TABLE 3
Flammability Testing Results for Carbon disulfide with Hydrocarbons
Balance of Each Mixture is the Carbon disulfide Fluid

| | mol % | AIT (° C.) | LFL (mol %) |
|---|---|---|---|
| Hydrocarbon | | | |
| CH₄ | 50% | 118 | 3.4% |
| C₂H₆ | 4% | 128 | 1.8% |
| | 8% | 126 | 2.5% |
| C₃H₈ | 4% | 124 | 2.3% |
| | 8% | 133 | 2.5% |
| C₄H₁₀ | 4% | 128 | 1.0% |
| | 8% | 138 | 1.0% |
| C₅H₁₂ | 4% | 102 | 2.1% |
| | 8% | 153 | 2.2% |
| C₆H₁₄ | 4% | 120 | 2.4% |
| | 8% | 144 | 2.3% |
| C₇H₁₆ | 4% | 134 | 2.1% |
| | 8% | 176 | 2.2% |
| Mixture of: | | | |
| C₂H₆ | 2% | 141 | 2.5% |
| C₃H₈ | 2% | | |
| C₄H₁₀ | 2% | | |
| C₅H₁₂ | 2% | | |
| Mixture of: | | | |
| C₄H₁₀ | 2% | 188 | 2.3% |
| C₅H₁₂ | 2% | | |
| C₆H₁₄ | 2% | | |
| C₇H₁₆ | 2% | | |

Flammability Results for Carbon Disulfide Mixtures with Disulfide Compounds

It was decided to perform tests of following additives:
1. Dimethyl Disulfide (C₁-DS)
2. Diethyl Disulfide (C₂-DS)
3. Dipropyl Disulfide (C₃-DS)
4. Di-t-butyl Disulfide (C₄-DS)
5. “Formulation A”: mixture of 1% C₁-DS, 62% C₂-DS, 31% C₃-DS, 6% C₄-DS
6. “Formulation B”: mixture of 3% C₂-DS, 70% C₃-DS, 27% C₄-DS

The additives were all tested at the concentration levels of 0.5%, 1.0%, 1.5%, and 2.0% by volume. Note that unlike the previous tests, the amount of disulfide compounds added to Carbon disulfide is based upon volume percentages to allow direct comparison with data from prior patents. In molar terms, the added amount of disulfide compounds would be less than in volume terms.

The rationale for testing the mixtures of disulfide compounds (“Formulation A” and “Formulatio B”) shown above is that these are typical compositions of waste products termed “Disulfide Oils” found in sour gas plants from the removal of mercaptans. Given that these disulfide oils are very difficult and costly to dispose, it was decided to test their effectiveness as additives to increase carbon disulfide autoignition temperatures. The results for the Carbon disulfide/disulfide mixtures are given in Table 4 and shown graphically in Table 5.

TABLE 4
Flammability Testing Results for Carbon disulfide with
Disulfide (DS) Compounds Balance of Each Mixture is the
Carbon disulfide Fluid.

| Component | vol % | AIT (° C.) | LFL (vol %) |
|---|---|---|---|
| C₁-DS | 0.5% | 172 | 0.7% |
| | 1.0% | 202 | 1.0% |
| | 1.5% | 202 | 1.0% |
| | 2.0% | 202 | 1.2% |
| C₂-DS | 0.5% | 162 | 0.6% |
| | 1.0% | 196 | 0.9% |
| | 1.5% | 197 | 1.4% |
| | 2.0% | 197 | 1.4% |
| C₃-DS | 0.5% | 146 | 0.8% |
| | 1.0% | 166 | 0.8% |
| | 1.5% | 186 | 1.0% |
| | 2.0% | 201 | 1.4% |
| C₄-DS | 0.5% | 131 | 0.5% |
| | 1.0% | 141 | 0.6% |
| | 1.5% | 146 | 0.8% |
| | 2.0% | 156 | 0.8% |
| Formulation A | 0.5% | 141 | 0.8% |
| | 1.0% | 166 | 0.8% |
| | 1.5% | 196 | 1.2% |
| | 2.0% | 196 | 1.2% |
| Formulation B | 0.5% | 139 | 0.7% |
| | 1.0% | 156 | 0.9% |
| | 1.5% | 156 | 0.8% |
| | 2.0% | 166 | 1.0% |

Relatively small amounts of disulfide compounds added to carbon disulfide can increase the AIT dramatically. Dimethyl disulfide (C₁-DS) appears to be the most effective in increasing the AIT, followed by diethyl disulfide (C₂-DS), dipropyl disulfide (C₃-DS), and di-t-butyl disulfide (C₄-DS). The benefits of C₁-DS and C₂-DS seem to plateau at 1.0%, however, with no additional benefits for greater quantities added. For the C₃-DS and C₄-DS cases, the autoignition temperatures continue to increase beyond 1.0% added, although they are still lower than for the C₁-DS and C₂-DS mixtures.

Illustrative Embodiments:

In one embodiment of the invention, there is disclosed a system for producing oil and/or gas comprising a formation comprising a mixture of oil and/or gas and an enhanced oil recovery mixture comprising an additive to increase an auto-ignition temperature of the mixture and a carbon disulfide formulation and/or a carbon oxysulfide formulation; and a mechanism for recovering at least a portion of the oil and/or gas. In some embodiments, the system also includes a mechanism for recovering at least a portion of the enhanced oil recovery mixture from the formation. In some embodiments, the mechanism for recovering at least a portion of the oil and/or gas comprises a well in the underground formation and a recovery facility at a topside of the well. In some embodiments, the system also includes a mechanism for injecting additional enhanced oil recovery mixture into the formation. In some embodiments, the system also includes a heater within the formation adapted to heat at least one of the enhanced oil recovery mixture, oil, and/or gas. In some embodiments, the system also includes a mechanism adapted to separate the recovered oil and/or gas from any recovered enhanced oil recovery mixture. In some embodiments, the system also includes a mechanism adapted to inject any recovered enhanced oil recovery mixture back into the formation. In some embodiments, the enhanced oil recovery mixture comprises at least about 1 molar percent of each of butane, pentane, hexane, and heptane. In some embodiments, the enhanced oil recovery mixture comprises at least about 2 molar percent of each of butane, pentane, hexane, and heptane. In some embodiments, the enhanced oil recovery mixture comprises at least about 30 molar percent of carbon disulfide. In some embodiments, the enhanced oil recovery mixture comprises at least about 30 molar percent of carbon oxysulfide.

In one embodiment of the invention, there is disclosed a method for producing oil and/or gas comprising providing a formation comprising oil and/or gas; and releasing an enhanced oil recovery mixture into the formation, the mixture comprising an additive adapted to increase an auto-ignition temperature of the mixture and at least one of carbon disulfide and/or carbon disulfide. In some embodiments, the method also includes recovering at least a portion of the oil and/or gas from the underground formation. In some embodiments, the recovering is done from a first well and the releasing the enhanced oil recovery mixture is done from the first well. In some embodiments, the recovering is done from a first well and the releasing the enhanced oil recovery mixture is done from a second well. In some embodiments, the recovering is done from a higher point in the formation, and the releasing the enhanced oil recovery mixture is done from a lower point in the formation. In some embodiments, the method also includes heating the enhanced oil recovery mixture prior to injecting the enhanced oil recovery mixture into the formation, or while within the formation. In some embodiments, the method also includes separating the enhanced oil recovery mixture from the oil and/or gas, and reinjecting the enhanced oil recovery mixture into the formation. In some embodiments, the method also includes converting at least a portion of a recovered oil and/or gas from the formation into a material selected from the group consisting of transportation fuels such as gasoline and diesel, heating fuel, lubricants, chemicals, and/or polymers.

In one embodiment, there is disclosed an enhanced oil recovery mixture comprising at least 1% molar butane, at least 1% molar pentane, at least 1% molar hexane, at least 1% molar heptane, and at least one of carbon disulfide and carbon oxysulfide. In some embodiments, the mixture comprises at least 2% molar butane, at least 2% molar pentane, at least 2% molar hexane, and at least 2% molar heptane. In some embodiments, the mixture also includes carbon dioxide. In some embodiments, the mixture also includes hydrogen sulfide. In some embodiments, the mixture comprises at least about 50% carbon disulfide. In some embodiments, the mixture comprises at least about 50% carbon oxysulfide.

Those of skill in the art will appreciate that many modifications and variations are possible in terms of the disclosed embodiments of the invention, configurations, materials and methods without departing from their spirit and scope. Accordingly, the scope of the claims appended hereafter and their functional equivalents should not be limited by particular embodiments described and illustrated herein, as these are merely exemplary in nature.

1. A system for producing oil and/or gas comprising:
a formation comprising a mixture of oil and/or gas and an enhanced oil recovery mixture comprising an additive to increase an auto-ignition temperature of the mixture and a carbon disulfide formulation and/or a carbon oxysulfide formulation; and
a mechanism for recovering at least a portion of the oil and/or gas.

2. The system of claim 1, further comprising a mechanism for recovering at least a portion of the enhanced oil recovery mixture from the formation.

3. The system of claim 1, wherein the mechanism for recovering at least a portion of the oil and/or gas comprises a well in the underground formation and a recovery facility at a topside of the well.

4. The system of claim 1, further comprising a mechanism for injecting additional enhanced oil recovery mixture into the formation.

5. The system of claim 1, further comprising a heater within the formation adapted to heat at least one of the enhanced oil recovery mixture, oil, and/or gas.

6. The system of claim 1, further comprising a mechanism adapted to separate the recovered oil and/or gas from any recovered enhanced oil recovery mixture.

7. The system of claim 6, further comprising a mechanism adapted to inject any recovered enhanced oil recovery mixture back into the formation.

8. The system of claim 1, wherein the enhanced oil recovery mixture comprises at least about 1 molar percent of each of butane, pentane, hexane, and heptane.

9. The system of claim 1, wherein the enhanced oil recovery mixture comprises at least about 2 molar percent of each of butane, pentane, hexane, and heptane.

10. The system of claim 1, wherein the enhanced oil recovery mixture comprises at least about 30 molar percent of carbon disulfide.

11. The system of claim 1, wherein the enhanced oil recovery mixture comprises at least about 30 molar percent of carbon oxysulfide.

12. A method for producing oil and/or gas comprising:
providing a formation comprising oil and/or gas; and
releasing an enhanced oil recovery mixture into the formation, the mixture comprising an additive adapted to increase an auto-ignition temperature of the mixture and at least one of carbon disulfide and/or carbon disulfide.

13. The method of claim 12, further comprising recovering at least a portion of the oil and/or gas from the underground formation.

14. The method of claim 13, wherein the recovering is done from a first well and the releasing the enhanced oil recovery mixture is done from the first well.

15. The method of claim 13, wherein the recovering is done from a first well and the releasing the enhanced oil recovery mixture is done from a second well.

16. The method of claim 13, wherein the recovering is done from a higher point in the formation, and the releasing the enhanced oil recovery mixture is done from a lower point in the formation.

17. The methods of claim 13, further comprising heating the enhanced oil recovery mixture prior to injecting the enhanced oil recovery mixture into the formation, or while within the formation.

18. The method of claim 13, further comprising separating the enhanced oil recovery mixture from the oil and/or gas, and reinjecting the enhanced oil recovery mixture into the formation.

19. The method of claim 13, further comprising converting at least a portion of a recovered oil and/or gas from the formation into a material selected from the group consisting of transportation fuels such as gasoline and diesel, heating fuel, lubricants, chemicals, and/or polymers.

20. An enhanced oil recovery mixture comprising at least 1% molar butane, at least 1% molar pentane, at least 1% molar hexane, at least 1% molar heptane, and at least one of carbon disulfide and carbon oxysulfide.

21. The mixture of claim 20, comprising at least 2% molar butane, at least 2% molar pentane, at least 2% molar hexane, and at least 2% molar heptane

22. The mixture claim 20, further comprising carbon dioxide.

23. The mixture of claim 20, further comprising hydrogen sulfide.

24. The mixture of claim 20, wherein the mixture comprises at least about 50% carbon disulfide.

25. The mixture of claim 20, wherein the mixture comprises at least about 50% carbon oxysulfide.
